(19) United States
(12) Patent Application Publication
(10) Pub. No.: US 2006/0059658 A1
(43) Pub. Date: Mar. 23, 2006

(54) Hinge member and a combination of a containing structure, lid and hinge combination and method

(75) Inventor: James Ahlfs, Bellingham, WA (US)

Correspondence Address: Hughes Law Firm, PLLC, Suite 302, 4164 Meridian Street, Bellingham, WA, 98226-5583, US

(73) Assignee: Heath Tecna, Inc.

(21) Appl. No.: 11/222,724

(22) Filed: Sep. 8, 2005

Related U.S. Application Data
(60) Provisional application No. 60/609,055, filed on Sep. 9, 2004.

(51) Int. Cl. E05F 1/08

(52) U.S. Cl. 16/306

(57) ABSTRACT

A hinge assembly having first and second hinge members with a limit section which places a limit on the distance which the two hinge members can be rotated away from one another. This limit section comprises a limit connecting member connecting from one hinge member and extending through a limit connecting opening in the other hinge member, with a limit member being connected to a forward end of the connecting member. Thus, when the two hinge members are moved away from one another, the limit member comes into contact with a back surface of the other hinge member to limit the further movement. The hinge is shown as part of a structural assembly where there is a lid over an opening, with the lid being spring loaded to move to its open position, and a latch mechanism to close the lid.

### RELATED APPLICATIONS

This application claims priority benefit of U.S. Ser. No. 60/609,055, filed Sep. 9, 2004.

### BACKGROUND OF THE INVENTION

a) Field of the Invention

The present invention relates to a hinge assembly, and more particularly to a hinge assembly where the rotational movement of the hinge members is limited, and also to a containing structure, lid and hinge combination and method.

b) Background Art

A common application of hinge members is to be used in connection with doors, lids, etc., and it is often desirable to limit the rotational movement of such lids or doors from the closed to open positions. A common means of accomplishing this is simply to have cushioned or resilient stop members (i.e. a door stop) at a wall location to prevent the door from crashing into an adjacent wall, with the knob of the door making a dent in the wall.

Also, it is common to have a device to limit the distance which in a lid can be opened. For example, a conventional piano bench commonly has a storage compartment where the sheet music or music books can be stored, with the top panel of the bench being hinge mounted to the bench to be able to function both as a lid and also providing a support surface for the person. When the top panel of the music bench is opened, it is usually desired that it be positioned where it will remain open while a person peruses through the music books or sheet music contained in the bench. Thus, there is quite often a pivot link which has a collapsed position and extended position where it positions the lid in a vertical position with a moderate backward tilt.

### BRIEF DESCRIPTION OF THE DRAWINGS

FIG. 1 is a side elevational view, partly in section, showing a hinge assembly of a first embodiment attached between a base structure and a door, with the door being in an intermediate position;

FIG. 2 is a isometric view of the hinge assembly in its open position, looking toward the front surfaces of the attachment portions of the two hinge members of the hinge assembly;

FIG. 3 is a isometric view looking toward the front surface of one of the hinge members and showing a back surface of the other hinge member;

FIG. 4 is a plan view looking directly at the back surface of one of the hinge members of a hinge assembly of a second embodiment;

FIG. 5 is a side elevational view of FIG. 4, showing the hinge members in their closed position substantially parallel and proximate to one another;

FIG. 6 is a side view similar to FIG. 5, but showing the hinge members in the open position;

FIG. 7 is a view taken from a vantage point located behind the hinge assembly as shown in FIG. 5;

FIG. 8 is a back plan view of the hinge assembly in its closed position as shown in FIGS. 4 and 5.

FIGS. 9 through 14 are five views of the hinge assembly without numerical designations and showing the design features of the hinge assembly, where:
i. FIG. 9 is an isometric view looking toward the front surfaces of the first and second hinge members in the open position;
ii. FIG. 10 is a view looking at the hinge assembly from a front location, again showing the front surface region of the first hinge member and viewing the hinge member along a line parallel to a plane defined by the second hinge member;
iii. FIG. 11 is a rear view taken from the back side of the hinge assembly as shown in FIG. 10;
iv. FIG. 12 is a bottom view of the hinge assembly, taken from a location removed by 90 degrees from the viewing location of FIG. 10;
v. FIG. 13 is a side view taken from one side of the hinge assembly; and
vi. FIG. 14 is a view similar to FIG. 13 but taken from an opposite side of the hinge assembly.

FIG. 15 is an isometric view illustrating the combination of a containing structure with a lid and hinge section, showing a further embodiment of the present invention;

FIG. 15A is an isometric exploded view of a portion of the containing structure and one lid with two hinge assemblies of the hinge section;

FIG. 16 is an isometric view taken from substantially the same location as in FIG. 15, showing only one of the hinge assemblies in its open position and adjacent portions of the lid and containing structure;

FIG. 17 is a side elevational view showing an upper portion of what is shown in FIG. 15; and

FIG. 18 is a side elevational view of one of the hinge members of the hinge assembly of the combination structure as shown in FIGS. 15-18.

### EMBODIMENTS OF THE PRESENT INVENTION

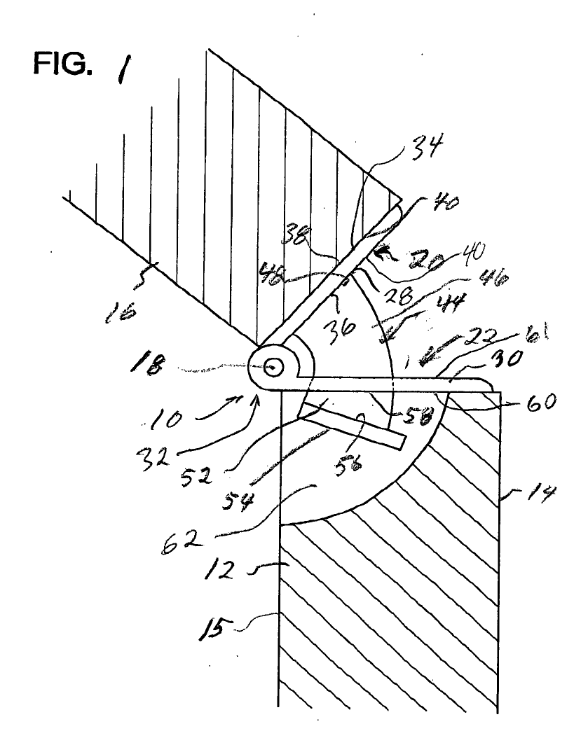

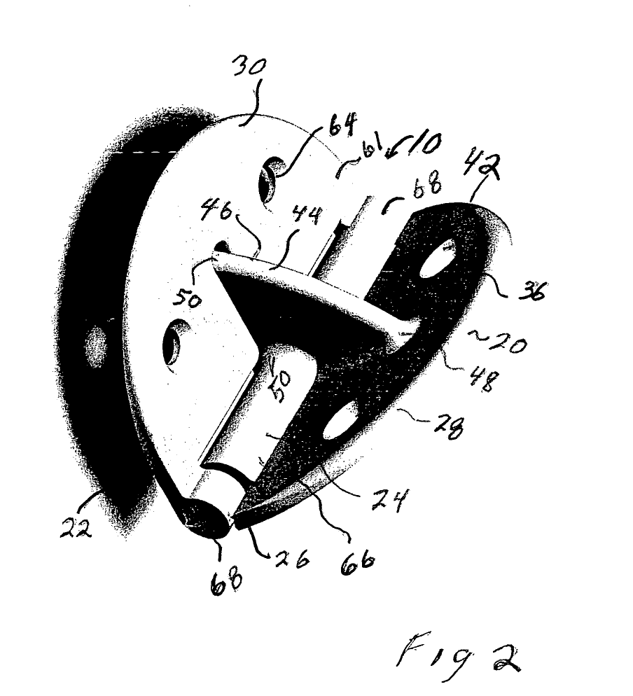

To describe a first embodiment of the present invention, reference is first made to FIG. 1 which shows a hinge assembly 10 used as a door hinge assembly. Thus, the hinge assembly 10 is connected to a base structure 12, such as a wall structure having an inner surface 14, and an outer surface 15, and is also connected to a door or lid 16. The door is connected to the hinge assembly 10 for rotation about a hinge axis 18 between a closed position and an open position, with FIG. 1 showing the hinge assembly 10 in a partially open position.

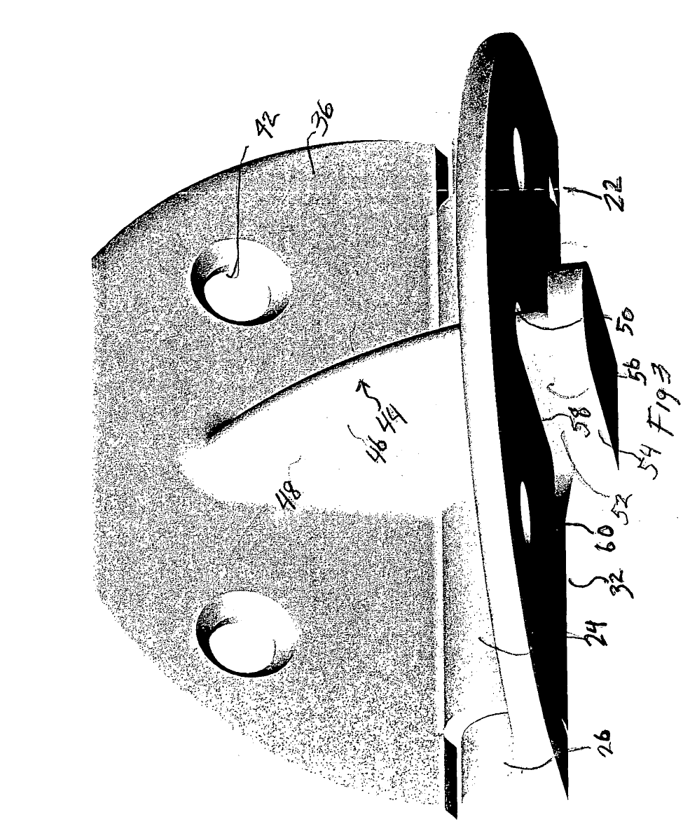

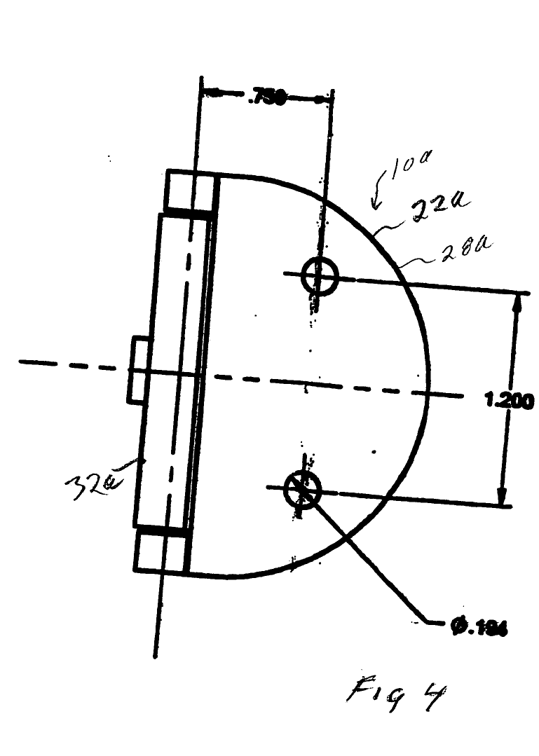

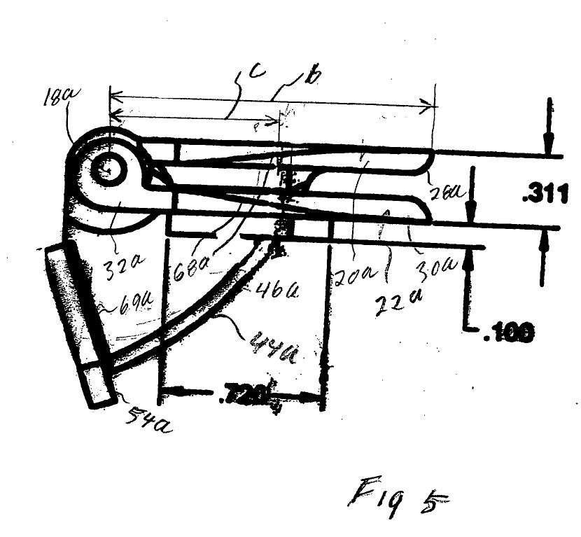

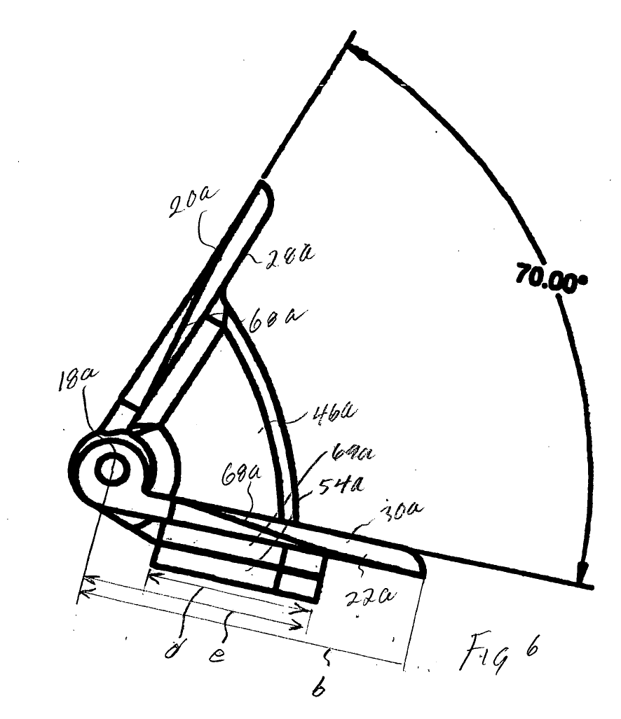

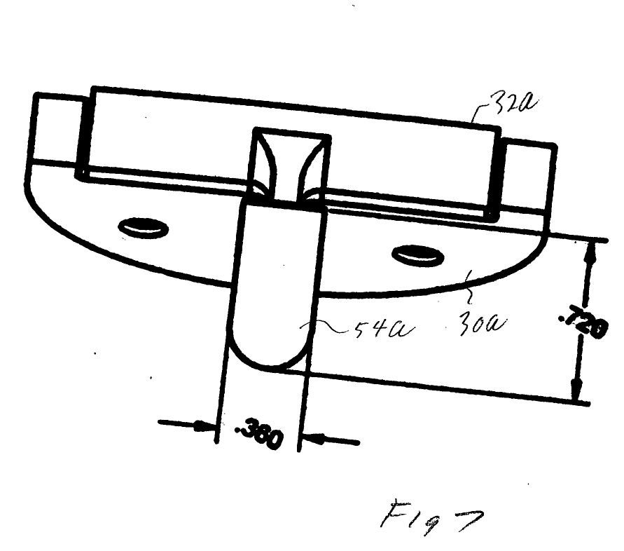

The hinge assembly 10 comprises first and second hinge members 20 and 22 which comprise, respectively, first and second hinge connected portions 24 and 26 (see FIG. 2) and first and second planar attachment portions 28 and 30. The two hinge connected portions 24 and 26 are interconnected with one another at the hinge axis 18 and these collectively function as a hinge connected section 32 about which the attachment portions 28 and 30 rotate.

The first attachment portion 28 of the first hinge member 20 comprises a back surface region 34 and a front surface region 36. The back surface region 34 has a first attachment 38 (surface regions) at which the first attachment portion 28 connects to the door 16. In this first embodiment, the first attachment area 38 is a planar surface which fits against a flat edge surface portion 40 of the door 16. The first attachment portion 28 is shown in FIGS. 2 and 3 as having a pair of openings 42 through which suitable connectors, such as wood screws, can be inserted to make the connection of the attachment portion 28 to the door.

The hinge assembly 10 further comprises a limit section 44 which limits the rotational movement of the door 16 to a given distance of travel between the open and closed positions. This limit section 44 comprises at least one connecting member 46 having a rear base end portion 48 that connects to the first attachment portion 28, and more specifically connects to a front surface region of the first attachment portion 28 of the first hinge member 20.

This connecting member 46 extends through a slot-like opening 50 formed in the second attachment portion 30 and has a front end portion 52 which connects to a limit member 54. This limit member 54 has a limit surface region 56 which faces toward a stop surface region 58 which is in this embodiment a portion of a second back surface region 60 of the aforementioned second attachment portion 30 of the second hinge member 22.

In FIG. 2 the limit member 54 is positioned so that it is a short distance away from the back surface region 60 so that a pad can be positioned on the surface region 56 of the limit member 54, and this will be shown in FIG. 4. However, the angular position of the limit member could be changed slightly to make it lie flush against the stop surface region 58, as in FIG. 1.

The second attachment portion 30 in overall configuration is substantially similar to the first limiting 28, and has a front surface region 61. With the door structure 16 in its closed position, the front surface region 61 of the second attachment portion is adjacent to the front surface region 36 of the first attachment portion 28 or in proximity thereto. The limit section 44 is centered along the hinge axis 18 so that the loads on the limit member are distributed evenly into the structure of the hinge assembly 10, and the connecting member has a planar configuration lying in a plane parallel to the hinge axis.

With further reference to FIG. 1 there is formed in the base structure 12 a recess 62 which is shaped and arranged to receive the limit member 54 and the intermediate and forward portion of the connecting member 46 when the door structure 16 is in its closed position. The base structure 12 could be made thicker to enclose the cavity 62 so that the limit member 54 would be concealed in the cavity 62. Also, the second attachment portion 30 is provided with attachment openings 64 to receive suitable fasteners such as wood screws, much in the same manner as the openings 42 located in the first attachment portion 28.

To comment on other features of the present invention the limit connecting opening 50 has a lengthwise axis having a substantial alignment component lying in a plane perpendicular to the hinge axis 18 of the hinge assembly. The connecting member 46 of the limit section 44 has a curved configuration with a curved alignment axis being a generally circular curve with the hinge axis being at least approximately at a radial center of the curve. Further, the limit connecting member has a thickness dimension generally parallel to the hinge axis and a width dimension aligned with a radius drawn from the hinge axis through the limit connecting member. The width dimension is substantially greater than the thickness dimension, and is desirably at least twice as great, or possibly three or four times as great as the thickness dimension.

Further, the limit member 54 has its limit surface region 56 positioned along both opposite sides of the front end portion 52 of the connecting member 46.

Also, the limit member 56 has a radially outward end portion at a radial distance from the hinge axis, and the second hinge member 22 has an outer edge portion having a radial distance from said hinge axis, and the radial distance of the outer end of the limit member is at least as great as one third of the radial distance to the outer edge of the second hinge member. Also, this radial distance of the limit member outward end portion is at least about one half or two thirds of the radial distance from the hinge axis to the outer edge of the second hinge member.

To describe the operation of this first embodiment, when the door 16 is its closed position, the two attachment portions 28 and 30 of the two hinge members 28 and 22 are in proximity with one another or in contact with one another, and also in parallel, or near parallel, relationship with one another. In that closed position, the limit member 54 and the major portion of the connecting member 46 of the limit section 44 are positioned in the recess 62 formed in the base structure 12.

When the door 16 is moved from its closed to its open position, the first hinge member moves with the door 16 moves rotatably about the hinge axis 18 in an arcuate path of travel. The limit member 54 is positioned so that when the door 16 reaches the location at which it is desired to limit any further rotational movement, the limit member 54 comes into engagement with the stop surface region 58 of the second attachment portion 30 of the second hinge member 22, thus limiting any further rotation of the door structure 16.

When the door is moved to its closed position, it moves with its first hinge member 20 in the opposite direction, so that the limit member 54 moves in an arcuate path of travel further into the recess 62 in the base structure 12.

The hinge section 32, made up of the two hinge portions 24 and 26, can be constructed and assembled in a conventional manner. As shown herein, the first hinge portion 24 comprises a generally cylindrical sleeve portion 66 positioned at, and concentrically with, the hinge axis 18. The first attachment portion 28 is fixedly connected to the sleeve 66 and extends generally radially outwardly from the hinge axis 18 but is offset therefrom by a short distance. Likewise, the connecting member 46 of the limit section 44 is fixedly connected to (or made integrally with) the first attachment portion 28. As shown herein, the attachment portion 28, as well as the attachment portion 30 having matching semi-circular configurations so that these are in congruent alignment with each other in the closed position in a manner that their perimeter edge portions are coincident with one other in a circularly curved alignment plane.

The hinge portion 26 of the second hinge member 22 is made of two cylindrical end portions 68 on opposite ends of the sleeve portion 66 and in alignment therewith. These two hinge portions 24 and 26 can then be connected rotatably to one another by positioning a center pin through axially aligned center openings in the two cylindrical end portions 67 and also through an axially aligned center opening in the sleeve portion 66.

As indicated previously, the opening 50 in the second attachment portion 30 is configured and positioned to accommodate the connecting member 46, and in this embodiment is formed as an elongate slot 50. Further in this particular arrangement the slot 50 is open at the radially inward end to provide a radially inward open slot. Thus in assembling the two hinge members 20 and 22, the connecting member 46 can simply be slipped into and through the open part of the opening 50 to the fully assembled position.

In this particular configuration, the connecting member 46 has a generally pie shaped configuration with the apex end portion of the pie shape being omitted so that the connection can be made to the sleeve portion 66.

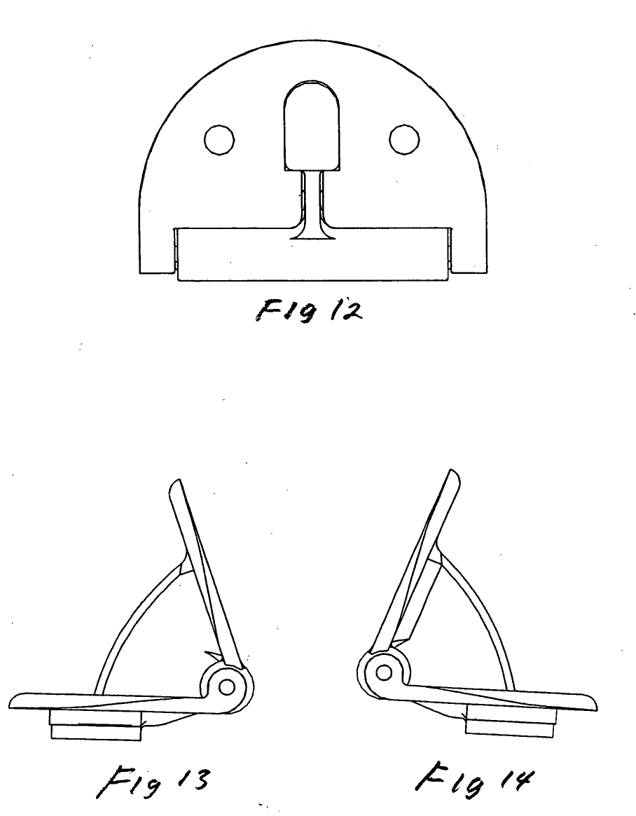

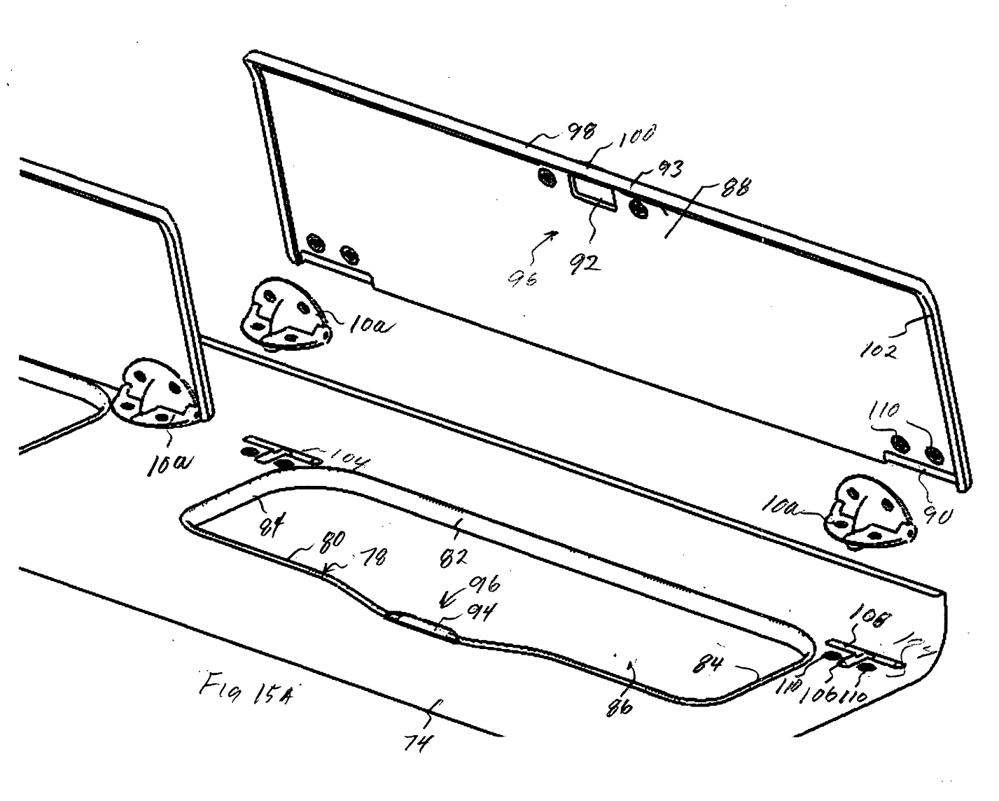

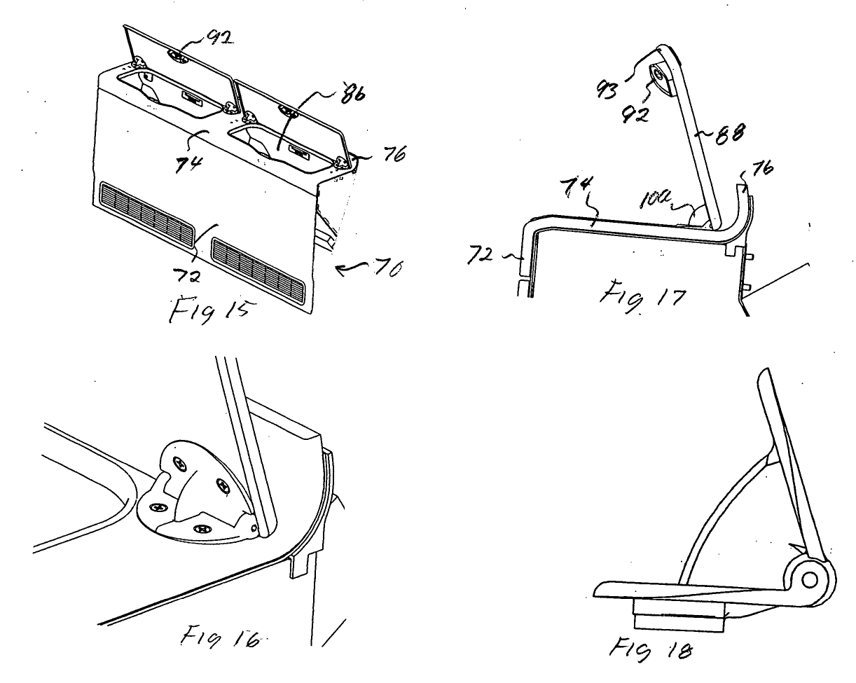

A second embodiment will now be described with reference to FIGS. 4 through 8. This second embodiment is particularly well adapted to be used with a lid that is used in combination with a structure, such as a console that is positioned next to a person, for example, when the person is a passenger in an aircraft or other transportation vehicle. This combination will be described later in this text with reference to FIGS. 15, 15A, 16, 17 and 18.

Components of this second embodiment which are similar to components of the first embodiment will be given like numerical designations with an “a” suffix distinguishing those of the second embodiment. The overall configuration of the two hinge members 20a and 22a of this second embodiment are substantially the same as the two hinge members 20 and 22 of the first embodiment. Therefore, the components of the first and second hinge members 20a and 20b will not be described in any detail in the following text, and there will not be numerical designations for many of the components of this second embodiment. Rather, several of the numerical designations will be placed in FIGS. 4 through 8 to indicate the corresponding sections of the second embodiment, with the understanding that the relevant descriptive text appearing earlier in this descriptive text applies as well to this second embodiment.

This second embodiment differs from the first embodiment in two respects. A first difference is that there is provided in the second embodiment a coil spring 68a which is positioned so that it urges the door or lid toward its open position. This could be accomplished in different ways. For example, there could be provided a cylindrical cavity or recess in the sleeve portion 66a, with the coil spring being positioned in the recess. Then the two arms 69a of the coil spring could reach radially outwardly to press against inside surfaces of the two attachment portions 28 and 30.

A second difference is that there is provided a damping pad 69a at the limit surface region 56a that is on the back surface of the second attachment portion 30a. Thus, when the coil spring 68a accelerates the door or lid toward its open position, when reaching the open position, the impact of the limit member 54a on the second attachment portion 30a of the second coil member 22 is dampened.

In both the first and second embodiments, each hinge assembly 10 and 10a can be provided as an assembled unit, in that it is preassembled prior to being installed.

FIGS. 4 through 8 are copies of drawings of an actual prototype that has been constructed. FIGS. 9 through 14 show the design features of the second embodiment without the numerical designations.

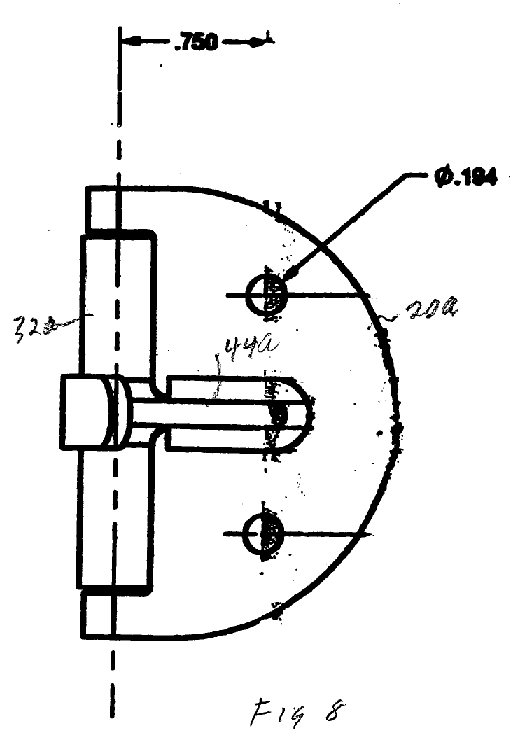

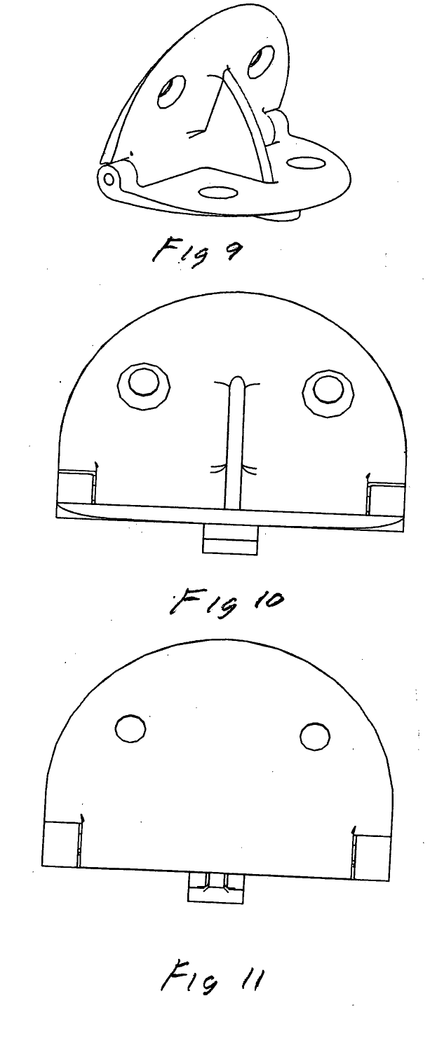

To discuss other features of the present invention, reference is made to FIGS. 5 and 6 which show various dimensional relationships. In FIG. 5, the dimension “b” extends from the hinge axis 18a to the outer edge portion of the two hinge members 20a and 22a. The dimension “c” is the radial distance between the hinge axis 18a and an outer edge of the curved connecting member 46. The dimension “d” (see FIG. 6) is the actual length of the limit member 54a. The dimension “e” is the distance from the hinge axis 18a to the outer edge of the limit member 54a.

In the following discussion, we will consider the distance “b” to be equal to 100%, and the other distances “c” through “e” will be given percentage values of the distance “b”. Thus, with reference first to FIG. 5, it can be seen that the distance “c” is about 50% (or a little bit more than 50%) than the overall distance “b” (which as indicated above is equal to 100%). With reference to FIG. 6 the distance “d” is about 50% (or slightly more than 50%) of the distance “b”. Finally, the dimension “e” is approximately 67% (i.e. about two thirds) of the total length of either of the hinge members 20a or 22a.

Let us now discuss some functional relationships in the hinge assembly and examine the situation where, for example, the hinge member 22a is connected to a stationary structure, and the other hinge member 20a is connected to a moveable member such as a lid. More specifically, let us assume that the hinge member 22a is horizontally positioned and is attached to a containing structure and the other hinge member 20a is attached to a lid for the containing member, and that the lid in the closed position is horizontally aligned.

Now let us assume that the lid is lifted until it reaches its end limit of travel where the limit member 54a engages the hinge member 22a. The entire surface of the limit member 54a would be pushing upwardly against the hinge member 22a from an outer location which is two thirds of the distance from the hinge axis 18a to the edge of the limit member 54a. This force is reacted into the fasteners which hold the hinge member 22a to the base structure of the containing member. This broader distribution of this force would avoid an undo concentration of loads that might occur in other situations where the load resulted in the form of a torque where the torque arm would be very short, so that for a given torque load, the concentration of the force close to the center of the applied torque would result in substantially higher load concentrations. This very brief commentary on the distribution of the loads is not intended to be any in depth analysis of variations in the distribution of these loads, but is simply to point out in broader terms these functional relationships.

These relative dimensions “c”, “d”, and “e” can be obviously be modified. For example, these dimensions “c”, “d” and “e” could be made larger up to 60%, 70%, or 80%, or possibly even higher. Alternatively, these could be made smaller by 5% increments to 45%, 40%, 35%, 30%, 25% or possibly lower. These values would depend upon the particular application for these hinges, how the loads would be imposed, design restraints resulting from other design mandates, etc.

To summarize somewhat broadly components and functional relationships of these embodiments, the hinge assembly is adapted for use with a door or lid and a base structure where the base structure has an open region and the door is mounted for limited rotational movement between a closed position and an open position.

This hinge assembly comprises the following:
a) there are first and second hinge members comprising first and second hinge portions, respectively, and first and second attachment portions, respectively;
b) the hinge portions are interconnected to form a hinge section having a hinge axis about which the first and second hinge members rotate relative to one another, with movement of the door structure between open and closed positions;
c) the first attachment portion has a first attachment surface region at which said first attachment portion is arranged to be attached to one of said door (or lid) or base structure and the second attachment portion has a second attachment surface region at which the second attachment portion is arranged to be attached to the other of the door (lid) or base structure, with each of the attachment portions having a front surface region positioned oppositely from the related attachment regions;
d) there is a limit section comprising a base portion connected to the first hinge member and having a first engagement portion positioned to come into limiting engagement with a second engagement portion at approximate to the second hinge member when the door structure is in its open position.
   It is obvious that various modifications could be made without departing from the basic concepts incorporated in these embodiments. For example, with further reference to FIG. 1, within the broader scope of the invention, there could be a reversal of parts, so that the connection member of the limit section 44 would not be connected to the first attachment portion 28, but would be connected to the second attachment portion 30 and extend through an opening in the first attachment portion 80. As a further example, while there is shown a single limit section 44 having a single limit member and a single connecting member 46, there could be two or more limit sections 44. Further this also could be done in a manner to have a reversal of parts.

For example, the single connection member 46 could be made as two members 46 and these would be connected to the cylindrical end portions 68 of the second hinge member 22.

Earlier in this text, it was stated that the second embodiment of the hinge assembly 10a was particularly adapted for use where there is a person who is seated next to a console, such as when the person is being seated in an airplane or other transportation vehicle with a console at his (her) side. In FIGS. 15, 15A-10, there is illustrated a console 70 which is positioned, for example, adjacent to a right side of a fuselage of an aircraft, and adjacent to a window seat of the aircraft.

The console 70 comprises a front wall 72 and a top wall 74 having a small curved upturned back portion 76. As shown in FIG. 15, the top panel 74 has two generally rectangular cut outs 78, each being surrounded by a perimeter edge comprising front, back and side edge portions 80, 82 and 84, respectively. Below each of the cut outs 78 is a related containing section which could contain various items, such as books, magazines, a desktop computer, etc. There is for each cut out 78 a related lid 88 which is hinge mounted along a rear edge portion 90 of the lid 88. Each lid has a front latch 92 at a forward edge portion 93 of the lid 88, and there is a console latch 96 positioned on the top panel 74 adjacent to the front edge of the cut out 78 to engage the front latch 92.

Each lid has a perimeter lip 98 extending a short distance downwardly from perimeter portion of the panel 74, this perimeter lip 98 having front and side portions 100 and 102 respectively.

Each of the lids 88 has a pair of the hinge assemblies 10a of the second embodiment. These two hinge assemblies 10a are located at respective hinge locations 104 (see FIG. 10A), which are located on the top surface of the panel 74 opposite locations, each adjacent to the back edge 82 of the perimeter of the cut out 78. Each of the hinge assemblies 10a is spaced from the side perimeter portions 84 of the cut out 78 by a short distance. At each of the hinge locations 104 on the top panel 74 there is a forward to rear through slot 106 to accommodate the connecting member 46a and a limit member 54 of the limit section 44a of the hinge assembly 10a. Also, there is at the rear end of each slot 106 a cross slot or recessed area 108 to accommodate the hinge portion of the hinge assembly 10a as needed.

Also, there are two attachment locations 110 to receive the fastening members (e.g. screws) that would connect the attachment portion 30a of the hinge assembly 10a. In like manner, there are connecting locations 112 positioned on each lid 88.

With the console 70 in its assembled position, each of the hinge assemblies 10a are positioned so that the entire hinge assembly 10a is positioned on top of the panel 74, except that the limit member 54a is positioned in the slot 104 in the panel 74. The two hinge members 20a and 22a are secured to the lid 88 and the top panel, respectively, in the position as shown in FIGS. 15 and 16. As indicated previously in this text, the spring member 68a in each hinge assembly urges the hinge member 20a to its open position. Thus, the travel in this particular embodiment of the lid 88 is about 70 degrees from the horizontal.

Normally, the passenger in the aircraft would move the lid 88 down to its closed position so that the two latch members 92 and 94 are latched to one another. When the person wants access to the containing section 86, he (she) simply releases the latch assembly 96, and the lid 88 is spring loaded to move to its upper position, as shown in FIGS. 15, 16, and 17.

Thus, the passenger would be able to release the latches 92 and 94 to cause the door to open due to the spring action of the hinge assemblies 10a, and then be able to select items from the containing section 86 with the lid 88 remaining open. Then the lid 88 can be pressed downwardly so that the latch member 92 and 94 come into engagement and the lid 88 is held in place.

As indicated earlier in this text, various modifications could be made in the present invention without departing from the basic teachings thereof.

Therefore I claim:

1. A hinge assembly comprising:
a) first and second hinge members, each comprising first and second hinge portions, respectively, and first and second attachment portions, respectively;
b) said hinge portions being interconnected to form a hinge section having a hinge axis about which the first and second hinge members rotate relative to one another, between an open position and a closed position;
c) said first attachment portion having a first attachment surface region at which said first attachment portion is arranged so as to be able to be attached to a first structure and the second attachment portion having a second attachment surface region at which the second attachment portion is arranged so as to be able to be attached to a second structure;
d) a limit section comprising a limit connecting member comprising a rear end portion and a forward end portion, said rear end portion connecting to said first hinge member with said limit connecting member extending forwardly from said rear end portion to extend through a limit connecting opening in said second hinge member, said limit section further comprising a limit member connected to the front end portion of the limit connecting member so that the rear and front end portions of the limit connecting member are on opposite sides of the second hinge member;
e) said limit member being configured and arranged so that said limit member, when in an operating position is not able to pass through said limit connecting opening;
whereby rotation of said second hinge member from its closed position said open position is limited by said limit member coming into engagement with said second hinge member.

2. The hinge assembly as recited in claim 1, wherein there is a spring device operatively connected to the first and second hinge members to urge said first and second hinge members to move toward the open position.

3. The hinge assembly as recited in claim 1, wherein said limit member 54 has at its surface region a cushioning contact surface.

4. The hinge assembly of claim 1, wherein said limit connecting opening has an elongate configuration with a lengthwise axis having a substantial alignment component lying in a plane perpendicular to the hinge axis of the hinge assembly.

5. The hinge assembly of claim 1, wherein said connecting member has a curved configuration with a curved alignment axis being a generally circular curve with the hinge axis being at least approximately at a radial center of the curve.

6. The hinge assembly as recited in claim 5, wherein said limit member has a thickness dimension generally parallel to the hinge axis and a width dimension aligned with a radius drawn from the hinge axis, said width dimension being substantially greater than the thickness dimension.

7. The hinge assembly of claim 6, wherein the width dimension is at least twice as much as said thickness dimension.

8. The hinge assembly of claim 7, wherein the width dimension is at least three times as much as said thickness dimension.

9. The hinge assembly of claim 8, wherein the width dimension is at least four times as much as said thickness dimension.

10. The hinge assembly of claim 1, wherein the front end portion of said limit member connects to a middle portion of said limit member and the limit member has a limit surface region to engage a stop surface region of the second hinge member, with the limit surface region being positioned along opposite sides of the forward end portion of the connecting member.

11. The hinge assembly of claim 10, wherein said limit member has a radially outward end portion at a radial distance from said hinge axis, and said second hinge member has an outer edge portion having a radial distance from said hinge axis, and the radial distance of the outer end of the limit member is at least as great as one third of the radial distance to the outer edge of the second hinge member.

12. The hinge assembly of claim 11, the radial distance of the outer edge of the limit member is at least one half as great as the radial distance of the outer edge member of the second hinge member.

13. The hinge assembly of claim 1, wherein said limit member has a radially outward end portion at a radial distance from said hinge axis, and said second hinge member has an outer edge portion having a radial distance from said hinge axis, and the radial distance of the outer end of the limit member is at least as great as one third of the radial distance to the outer edge of the second hinge member.

14. The hinge assembly of claim 13, the radial distance of the outer edge of the limit member is at least one half as great as the radial distance of the outer edge member of the second hinge member.

15. A container, lid and hinge combination containing a hinge structure comprising:
a) a containing structure comprising a base having a top panel, and a containing section below said top panel, said panel having a panel opening defined by forward, rear and side perimeter portions and a panel opening connecting to said containing section and defined by opening edge portions located in said panel around said opening, said opening edge portion having front, rear and side opening edge portions;
b) a generally planar lid at said panel opening, said lid having upper and lower surfaces, and front, rear and side edges surrounding said lid, said lid having a closed position where said lid is positioned over said panel opening and an open position, said lid being hinge mounted about a panel hinge axis at, or near to, its rear edge portion to said top panel at, or near to, the rear opening edge portion of the top panel;
c) a pair of hinge assemblies interconnecting said lid with said top panel at spaced locations along said panel hinge axis, each of said hinge assemblies comprising:
i. first and second hinge members, each comprising first and second hinge portions, respectively, and first and second attachment portions, respectively;
ii. said hinge portions being interconnected to form a hinge section having a hinge axis about which the first and second hinge members rotate relative to one another between an open position and a closed position and having a spring mechanism to urge the hinge members to the open position;
iii. said first attachment portion having a first back surface with a first attachment surface region at which said first attachment portion is attached to the bottom surfaces of the lid, and said second attachment portion having a second back surface with a second attachment surface region at which the second attachment portion is to the upper surface of the top panel attached.
iv. a limit section comprising a limit connecting member comprising a rear end portion and a forward end portion, said rear end portion connecting to said first hinge member with said limit connecting member extending forwardly from said rear end portion to extend through a limit connecting opening in said second hinge member, said limit section further comprising a limit member connected to the front end portion of the limit connecting member so that the rear and front end portions of the limit connecting member;
v. said limit member being configured and arranged so that said limit member in an operating position is not able to pass through said limit connecting opening;
d) each hinge assembly being positioned so that the hinge axis of the hinge assembly coincides with the panel hinge axis, said panel having a through slot aligned with the limit connecting opening in the second hinge member, and with the limit connecting member being positioned to extend through the slot of the panel in a manner that the limit member is able to move toward and away from the panel in a location beneath said panel as said lid is moved upwardly and downwardly to cause back and forth movement of said limit member.

16. The hinge assembly of claim 15, wherein said limit connecting opening has an elongate configuration with a lengthwise axis having a substantial alignment component lying in a plane perpendicular to the hinge axis of the hinge assembly.

17. The hinge assembly of claim 15, wherein said connecting member has a curved configuration with a curved alignment axis being a generally circular curve with the hinge axis being at least approximately at a radial center of the curve.

18. The hinge assembly as recited in claim 17, wherein said limit member has a thickness dimension generally parallel to the hinge axis and a width dimension aligned with a radius drawn from the hinge axis, said width dimension being substantially greater than the thickness dimension.

19. The hinge assembly of claim 15, wherein the thickness dimension is at least three times as much as said width dimension.

20. A method of providing a container, lid and hinge combination containing a hinge structure, said method comprising:
a) providing a containing structure comprising a base having a top panel, and locating a containing section below said top panel, then providing a panel opening defined by forward, rear and side perimeter portions and a panel opening connecting to said containing section and defined by opening edge portions located in said panel around said opening, said opening edge portion having front, rear and side opening edge portions;
b) positioning a generally planar lid at said panel opening, said lid having upper and lower surfaces, and front, rear and side edges surrounding said lid, said lid having a closed position where said lid is positioned over said panel opening and an open position, said lid being hinge mounted about a panel hinge axis at, or near to, its rear edge portion to said top panel at, or near to, the rear opening edge portion of the top panel;
c) providing a pair of hinge assemblies and interconnecting said lid with said top panel at spaced locations along said panel hinge axis;
d) providing said hinge assemblies with first and second hinge members, each comprising first and second hinge portions, respectively, and first and second attachment portions, respectively;
e) having said hinge portions being interconnected to form a hinge section having a hinge axis about which the first and second hinge members rotate relative to one another between an open position and a closed position with said first attachment portion having a first back surface with a first attachment surface region;
f) attaching said first attachment portion to the bottom surfaces of the lid;
g) providing said second attachment portion with a second back surface with a second attachment surface region and attaching the second attachment portion at said second back surface portion to the upper surface of the top panel attached;
h) positioning a limit section comprising a limit connecting member comprising a rear end portion and a forward end portions, said rear end portion connecting to said first hinge member with said limit connecting member extending forwardly from said rear end portion to extend through a limit connecting opening in said second hinge member, said limit section further comprising a limit member connected to the front end portion of the limit connecting member so that the rear and front end portions of the limit connecting member, said limit member being configured and arranged so that said limit member in an operating position is not able to pass through said limit connecting opening;
i) positioning each hinge assembly so that the hinge axis of the hinge assembly coincides with the panel hinge axis, with said panel having a through slot aligned with the limit connecting opening in the second hinge member, and with the limit connecting member being positioned to extend through the slot of the panel in a manner that the limit member is able to move toward and away from the panel in a location beneath said panel as said lid is moved upwardly and downwardly to cause back and forth movement of said limit member.
